(19) United States
(12) Patent Application Publication
(10) Pub. No.: US 2014/0076667 A1
(43) Pub. Date: Mar. 20, 2014

(54) ELEVATOR WITH CAR MOVABLE IN SERVICE MODE

(71) Applicant: Markus Henseler, Immensee (CH)

(72) Inventor: Markus Henseler, Immensee (CH)

(73) Assignee: INVENTIO AG, Hergiswil (CH)

(21) Appl. No.: 14/006,756

(22) PCT Filed: Mar. 21, 2012
(86) PCT No.: PCT/EP2012/001248

§ 371 Date: Dec. 2, 2013

(30) Foreign Application Priority Data
Mar. 21, 2011 (CH) 0468/11
Mar. 21, 2011 (CH) 0469/11
May 18, 2011 (CH) 0842/11

(51) Int. Cl. B66B 5/00

(52) U.S. Cl. CPC B66B 5/0087
USPC 187/247

(57) ABSTRACT

An elevator car can be moved in service mode by a control unit in the interior of the car. The control unit can be accommodated behind a part, which is removable, pivotable out or displaceable, in the ceiling or light in the car, or behind a wall part, which is removable, pivotable open or displaceable, of the car. The control unit can hang at a cable and be removable from a storage niche to be actuable from any location in the interior of the car. The control unit can be a wireless transmitter which co-operates with a wireless interface at the car. Since car is movable, controlled from the interior, to any desired point of the travel path and can be stopped at any desired point all maintenance operations can be performed from the car.

### FIELD

This invention relates to an elevator in which the elevator car is movable in service mode controlled from its interior.

### BACKGROUND

For constructional reasons in most conventional elevator constructions the region above or the region below the elevator car has to be accessible and, in particular, regardless of where the elevator car happens to be located. If the region below the elevator car is to be accessible, there is the risk that a person, who is present there, is injured by downward travel of the elevator car unintentionally taking place. Safety precautions are therefore necessary to reliably prevent such an event. Accordingly, a temporary or permanent protective space has to be present of at least the size of a block F with the minimum dimensions of 0.5 meters×0.6 meters×0.8 meters on the upper car side or 0.5 meters×0.5 meters×1.0 meter on the lower car side so that even in the case of an upward or downward movement—which in fact is highly improbable—of the elevator car the service operative would be enclosed by the protective space and therefore protected from injuries. These protective measures as well as the constructions of most elevators prevent elevator cars from being able to be moved down until quite close to the shaft floor or to be moved in upward direction until quite close below the shaft ceiling. In other words, the elevator car is always longer by a certain minimum dimension than the effective travel path of the elevator car and, more precisely, also longer than the effective maximum distance between elevator car roof in the uppermost position of the elevator car to below the floor of the elevator car in its lowermost position. This fact in many cases makes installation of an elevator impossible, because it is not possible to realize the shaft pit to the necessary depth or the shaft head to prescribed shaft head height for constructional reasons.

As a central prescription it is necessary in new elevator installations to avoid risk of crushing in the end settings of the elevator car, thus by free spaces or protective niches. Due to the wording of No. 2.2 in the Lifts Ordinance and EEC lift guidelines this means that for lawmakers optimum safety is achieved with a compulsory prescribed protective space.

The region below the elevator car in the lowermost access level represents a particular problem. Since it can commonly happen that there is somebody standing in the shaft pit, thus on the floor of the elevator shaft, whether for maintenance purposes or cleaning purposes, strictly prescribed temporary or permanent protective precautions must be present to reliably prevent this person from being able to be injured or crushed in the case of unintended downward travel of the elevator car. An elevator without an elevator shaft pit or with a minimum elevator shaft pit depth, with an elevator car, which is movable in an elevator shaft with shaft doors to several access levels and the maintenance operations of which are performable exclusively from outside the interior of the elevator car can be realized if access to the region below the elevator car is made impossible by technical measures and the permanent protective space consists of the entire interior of the elevator car itself. Then, however, the question is posed as to how, for example, the shaft doors and the drives thereof can be maintained. These are conventionally made accessible by opening the shaft doors from the access level in that the car in service mode is moved, controlled from outside, somewhat upwardly or downwardly so that the regions above and below the shaft doors are reachable from the interior of the elevator if the elevator car doors do remain open.

### SUMMARY

An object of the present invention is now to find a solution to enable all maintenance operations, which have to be performed at an elevator, to be carried out from the interior of the elevator car, in particular also at any shaft doors intentionally non-openable from the outside, i.e. from the access levels.

This object is fulfilled by an elevator with an elevator car and with a control unit, wherein the elevator is sellable into a service mode and in this service mode the elevator car is movable by means of the control unit from the car interior.

By control unit there is understood here an inspection control unit by which a car journey in service mode is controllable. For that purpose the control unit comprises at least two operating elements, namely a first operating element by way of which car travel in upward direction is actuable and a second operating element by way of which car travel in downward direction is actuable. The operating element is typically executed as a button or the like. Moreover, the control unit is connected with a drive control of the elevator. On actuation of the first operating element the drive control controls the drive in such a way that the car is moved upwardly. Correspondingly, on actuation of the second operating element the drive control controls the elevator car in such a way that the elevator car is moved downwardly.

In a preferred embodiment the control unit is constructed as a keyboard which is arranged in the region of the interior space of the elevator car and in operating mode serves as an interface for destination input for car travel to an access level and in a service mode as an interface for input of a travel direction. In this regard, by keyboard there is understood, apart from a board with a plurality of buttons which are physically present, also a touch-sensitive image screen with a plurality of input fields which are visualized on the image screen and which constitute virtual buttons. In that case, it is advantageous that the control unit can be realized in cost-saving manner by means of elevator components which are already present.

The keyboard is preferably indirectly or directly connected with the drive control. Thus, in operating mode destination inputs can be communicated at the keyboard to the drive control.

The button assignment of the keyboard in operating mode is preferably configured for destination input of car travel to an access level. The keyboard typically comprises a number of buttons corresponding with the number of access levels. A passenger can communicate his or her destination by actuation of a button. Alternatively thereto the keyboard can equally be designed as a decade keyboard in which case a passenger communicates his or her destination by means of actuation of one or more buttons.

The keyboard is preferably activatable as a control unit of car travel in service mode. The activation takes place by way of input of a predeterminable button combination at the buttons of the keyboard. Alternatively thereto the keyboard is activatable by way of actuation of a key or cable-free transmission of a code by means of an authorization card or the like. In this alternative embodiment the elevator comprises a lock or an interface for cable-free transmission of the code. It is thus ensured that activation of the keyboard for car travel in service mode is reserved to service personnel. The lock or the interface is arranged in the region of the car interior. With particular preference the lock or the interface is arranged in the immediate vicinity of the keyboard or at the keyboard itself.

For preference the button assignment of the keyboard can be reconfigured in the service mode for input of a travel direction of the elevator car . At least one first button and at least one second button for control of the travel direction of the elevator car can be reconfigured for control of the car travel in service mode. In that case the button assignment is reconfigured in such a manner that on actuation of the first button the elevator car is movable in upward direction and on actuation of the second button the elevator car is movable in downward direction. The invention is not confined to a concrete arrangement of the buttons actuable in service mode and is freely selectable by the expert. In a particularly preferred embodiment, reconfiguration of the button assignment for control of the car travel can be visually indicated at the buttons, for example by lighting up the corresponding buttons or by adaptation of the operating fields displayed in the touch-sensitive image screen.

For preference, the keyboard is deactivatable as control unit of car travel in the service mode. After the conclusion of the maintenance or inspection operations the keyboard is free again for destination input for car journeys in the operating mode. Accordingly, the deactivation brings the button assignment of the keyboard back to the original configuration of the operating mode. For that purpose the keyboard is deactivated by means of input of a predeterminable button combination, actuation of the key or cable-free transmission of a code or brought from the service mode to the operating mode. In that case, the button combination or the code for the deactivation can differ from the button combination or code for the activation.

### DESCRIPTION OF THE DRAWINGS

An elevator is illustrated over four access levels as an example in the drawings and the performance of the maintenance operations is explained on the basis of this example, wherein:

FIG. 1 shows an elevator with four access levels, with a minimum elevator shaft pit depth, with the elevator car in the uppermost access level;

FIG. 2 shows this elevator with the elevator car during upward or downward travel in the service mode;

FIG. 3 shows this elevator with the elevator car in service mode moved to the drives of the lowermost shaft doors and subsequently opened elevator car doors; and

FIG. 4 shows this elevator with the elevator car in service mode moved close to the floor of the lowermost access level, and subsequently partly opened car floor.

### DETAILED DESCRIPTION OF THE INVENTION

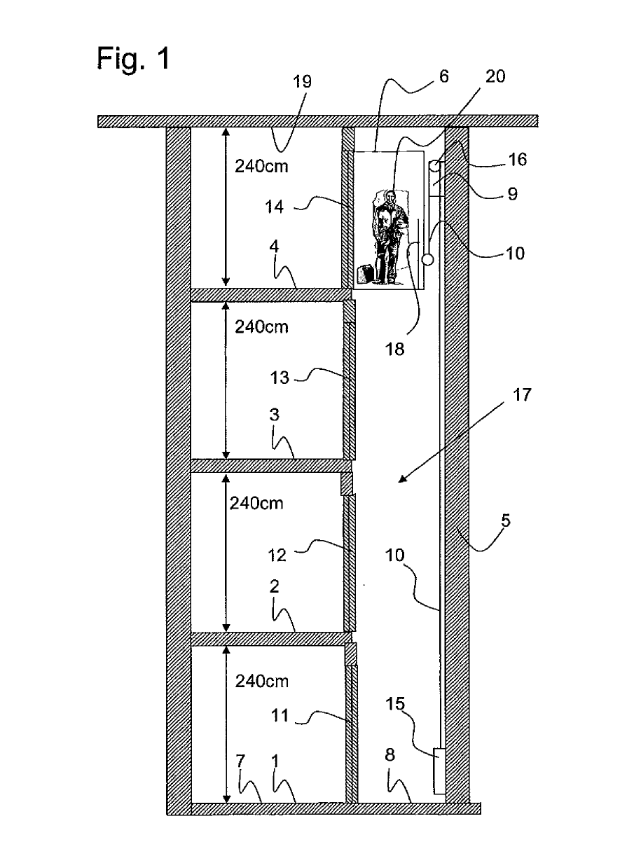

FIG. 1 shows a cross-section through a building with four floors or access levels 1 to 4, which are all accessed by the elevator car 6 of the elevator. The principle on which this invention is based is explained by way of this drawing. In that case, however, it is clear that such an elevator can be guided over fewer or also many more floors. In addition, the drive can be resolved differently from that illustrated here and includes all known drive variants, regardless of kind. The construction shown here is thus solely an exemplifying construction and is not in any way to be understood as restricting the scope of protection. The elevator shaft 5 is here virtually the same height as the distance between the floor 7 of the lowermost access level 1 and the ceiling 19 of the uppermost access level 4. The elevator car 6 is here in its uppermost position, i.e. on the uppermost access level 4. If the elevator car 6 subsequently lies in its lowermost position virtually on the lowermost access level 1 then the car floor thereof, which does also have a certain thickness, lies by its upper side in the same plane as the finished floor covering 7 of the lowermost access level 1. The protective space F of this elevator is always and permanently formed by the elevator car 6 itself, as will be still explained. The drive of this elevator is carried out in the illustrated example by a drive unit in the form of a gearless external rotor, which is fastened in a frame 9 to the shaft wall and is supported on guide rails (not illustrated). The external rotor forms a drive pulley 16 and the support means 10, which on the one hand carry the elevator car 6 and on the other hand the counterweights 15, run over this. The elevator car 6 is as usual guided along rails which are anchored to the elevator shaft wall, but are not illustrated here. The elevator car 6 can in the illustrated example be moved past this drive unit. A wall part 18 of the elevator car 6 can be removed in order to free a maintenance opening and then access to parts, which have to be maintained, is ensured for the service operative 20, so that the maintenance operations can be carried out by him or her from the elevator car 6, as described in detail in, for example, WO 2008/095324. There is no reason to climb onto the elevator car roof.

If the elevator is constructed so that all maintenance operations can be carried out from the interior of the elevator car then the elevator car itself forms a permanent protective space, regardless of when and regardless of where it is at rest. If, thus, the entire protective space is within the elevator car, then that is a permanent protective space. If there is too little space in the shaft head and maintenance operations have to be carried out there, then the roof of the elevator car can be constructed so that if a person stands thereon the protective space extends partly into the car. However, that is a temporary measure which is utilized only if the roof drops. If the car roof is thus constructed to drop so that the protective space can protrude from the outside into the car then that is a temporary solution and this is subject to approval from case to case for operation of the elevator. If, thereagainst, there is a permanent protective space, such as illustrated here, then it is possible to construct from the outside whatever is wanted, regardless of what and how, even when the shaft ceiling in the uppermost stopping position of the elevator car is located a mere 1 millimeter above the car, the protective space thus always being present without restriction. Such a permanent protective space then makes sense primarily when all maintenance operations can be performed from outside the interior of the elevator car. In the elevator car, which then forms the prescribed permanent protective space, there is then, in particular, always and in general the protection to full scope without any particular measures and without any particular special precautions. The special feature of a permanent protective space consists in that protection to the full scope is always and in general guaranteed in the elevator car without any particular measures having to be initially carried out and without any particular special precautions or changes having to be undertaken first. Thereagainst, a protective space which projects only partly into the elevator car counts, according to regulations, as a temporary and thus non-permanent protective space, because something has to firstly happen at the car roof so that the protective space is created. Similarly, only a temporary protective space is present when, for example, initially a safety circuit has to be activated or a drive has to be blocked or a support has to be inserted or folded down or whatever other measures have to be carried out in order to ensure the presence of a protective space.

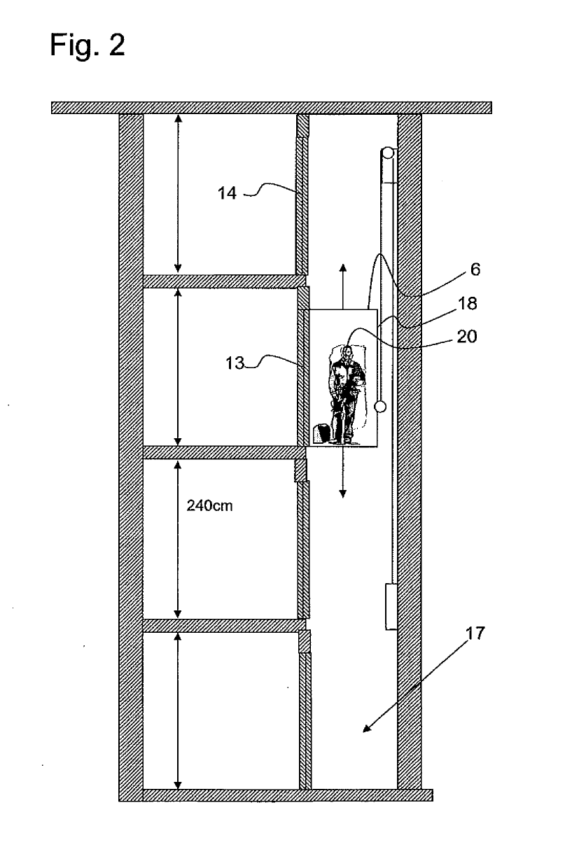

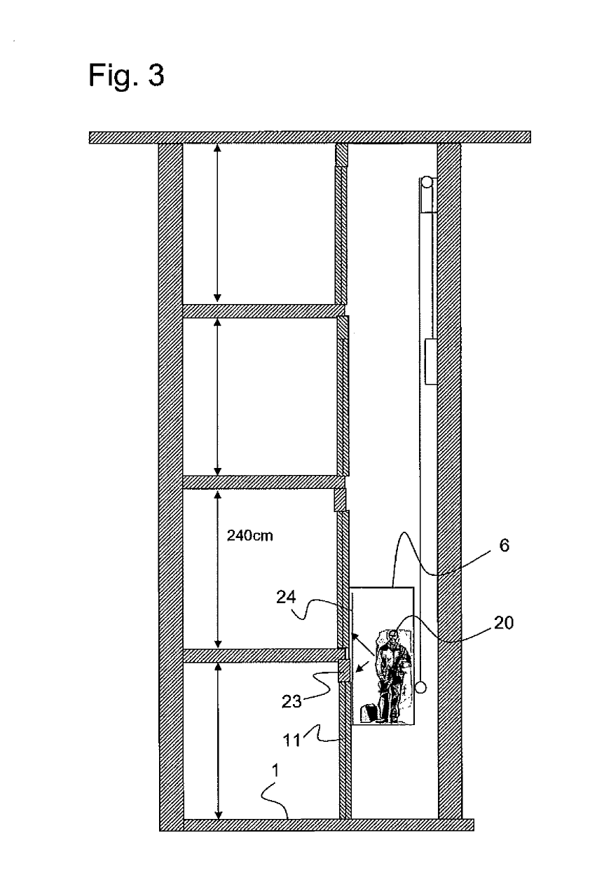

What is the situation with regard to the region below the elevator car? If anybody is there then this person would be crushed on downward movement of the elevator car to the lowermost access level 1. In the lowermost position of the elevator car 6 it virtually stands on the floor 8 of the elevator shaft region 17, as can be seen on the basis of FIG. 3. How is it possible to thus securely and effectively prevent anybody from being trapped between the underside of the elevator car 6 and the floor 8 of the elevator shaft 17? That is managed in such a way that the entire region 17 below the elevator car 6, as it is designated in FIGS. 1 and 2, is safeguarded by technical precautions so as to never be able to be entered. Consequently, nobody can ever be in this region 17 and therefore also nobody can ever come to harm by complete downward movement of the elevator car 6 to the lowermost access level 1. These technical precautions consist in that the shaft doors 11-13, with the exception of the door 14 of the uppermost access level 4, cannot be opened as long as the elevator car 6 is not stopped at the corresponding access level.

In conventional elevators the shaft doors can usually be unlocked and opened in the case of emergency by a box spanner. Depending on where the elevator car is currently located it is then possible when the shaft door is open to look onto it from above or from below onto the elevator car located further above and access into the elevator shaft is possible through any shaft door, even access into the elevator shaft below the elevator car. If a conventional elevator thus has a shaft pit, then this is always accessible in that the elevator is moved into a position above the lowermost access level and thereafter the lowermost shaft door can be unlocked, whereafter it is possible to climb down into the shaft pit, for example to carry out whatever maintenance operations there, in order to clean something or, for example, in order to extract an object which unintentionally fell into the pit. This access has to be accompanied on every occasion by a temporary protective precaution which ensures that the elevator car cannot travel beyond the standing region in the shaft pit and thus that a minimum protective space F below the elevator car of at least the size of a block F with the minimum dimensions of 0.5 meters×0.6 meters×1.0 meter is always present. Thus, for example, a temporary support is mounted or downward travel of the elevator car is blocked by a temporary lock so as to ensure the presence of this protective space F.

In the case of the elevator presented here, however, walking into the region 17 below the elevator car 6 is in general, i.e. in all conceivable cases, made absolutely impossible by way of technical precautions. Accordingly, there is also at no time a risk of a person being able to come to harm below the elevator car 6 by downward travel thereof. As mentioned, the technical precautions consist in that all shaft doors 11-13 with the exception of the uppermost shaft door 14 are always locked when the elevator car 6 is not currently located at the relevant access level. Thus, only when the elevator car 6, for example, stops on the access level 3 can the shaft door 13 present thereat open. These shaft doors 11-13 accordingly have absolutely no emergency unlocking even if intended and therefore can never be opened from the outside if the elevator car is not currently stopped in front of the shaft doors 11-13. The elevator car 6 can move away only if a previously opened shaft door is firstly closed again and locked. All shaft doors 11-13 offer solely access to the interior of the elevator car 6, but never into the interior of the elevator shaft 5 above or below the elevator car. Only the uppermost shaft door 14 allows both access to the interior of the elevator car 6 and access to the region above the elevator car 6. Access to the elevator car 6 is made possible obviously when the elevator car 6 is stopped at the uppermost access level 4. If, however, the elevator car 6 is stopped further below, the uppermost shaft door 14 by means of an intrinsic emergency unlocking makes possible access to the elevator shaft 17, but exclusively to the region above the elevator car 6 and never below the same.

The shaft 17 is thus accessible solely by way of the uppermost shaft door 14, by way of emergency unlocking means, which is not intentionally present at all other shaft doors 11-13. Nothing can ever happen below the elevator car 6, because this region is for technical reasons never accessible and a protective space below the elevator car is therefore superfluous. The service operative is present on the car with sufficient protective space or appropriate protective measures or only in the interior of the elevator car 6, which at the same time forms the permanent protective space.

For constructional reasons the shaft doors 11-13 cannot indeed be unlocked if the elevator car 6 is not at the level of the relevant shaft door. The uppermost shaft door 14 forms the sole exception where that is possible. If the elevator car has stopped in front of a shaft door, the shaft door opens in conventional manner. In this state the service operative can go into the interior of the elevator car 6 and check everything at the shaft door as well as at the elevator car door, which is also visible to normal users. However, the service operative in this position of the elevator car cannot check or repair the mechanism and control of the shaft doors 11-13. The door drive and the locking mechanism of the shaft doors 11-14 are, in particular, located above the interior ceiling of the elevator car. In order that these parts are nevertheless accessible for maintenance and possibly necessary repair this elevator allows the possibility of being moved in the service mode from the car.

For preference, the elevator car 6 in the service mode is movable with closed elevator car door 24 and open maintenance opening in controlled manner, by way of the control unit, from the car interior. Alternatively thereto the elevator car 6 is movable in controlled manner in service mode also in closed state by way of the control unit from the car interior. In that case, not only the elevator car door 24, but also the maintenance opening are closed.

For that purpose the elevator car 6 can, for example, have a removable part 25 in the ceiling, the wall or the light of the elevator car 6, behind which a control unit 26 for controlling car travel in the service mode is concealed, for example in the form of a stationary control strip or a control strip, which can be removed and which hangs at a cable 27, so that the service operative gains freedom of movement and can be in any desired position in the interior of the closed elevator car and nevertheless can conveniently actuate the control and can travel up and down in service mode. The control unit 26 can also be installed in a niche 28 in the interior of the elevator car, which is closable by a push door or panel door, or by a separate cover which can be placed on. In addition, the control can also be realized in that plug positions are provided at the inner side of the elevator car, for example USB plug positions. The service operative then brings his or her control apparatus with them or stores this at a suitable place in the elevator and then produces the electrical connections with the drive and his or her electronic control system by way of the plug positions, so that the operative can travel up and down in the elevator car in service mode. The control unit can also be wirelessly connected with the drive control. The service operative then has a transmitter which is connected with the drive control by way of a wireless interface.

Moreover, the control unit can, for movement of the elevator car, be activated in the service mode also by way of an already-present keyboard 29. In the illustrated embodiment of the elevator with four access levels 1-4 the keyboard preferably has four buttons. In the operating mode the keyboard serves as input interface for destination input of a car journey to a desired access level 11-14. Preferably, activation of the keyboard as a control unit for travels in the service mode is carried out by means of input of a predetermined button combination. After activation, the button assignment at the keyboard is configured for controlling a service journey. Thus, for example, an upper button can be actuated for a journey in upward direction and a lower button for a journey in a downward direction. Alternatively to activation of the keyboard as control unit for car journeys in the service mode a service journey of the elevator car can take place directly on the basis of specific button combinations. For that purpose, for example, a first combination of several predeterminable buttons of the keyboard can be actuated at the same time for a journey in upward direction and a second combination of several predeterminable buttons of the keyboard can be actuated simultaneously for a journey in downward direction. After the conclusion of the maintenance operations the keyboard is again deactivatable as a control unit in service mode, i.e. the keyboard can be brought from the service mode to an operating mode. In that case the button assignment is also brought into the original configuration for the destination input.

Finally, a keyboard 29 can be mounted behind a cover 25 at a wall of the elevator car 6. In this embodiment the keyboard serves as a control unit for car journeys in the service mode apart from an already present keyboard for the destination input for journeys to an access level in the operating mode.

The service mode makes it possible for the elevator car of the elevator to travel as slowly as desired and stop at any desired point. Correspondingly, the service operative can, from a specific access level in the service mode, move slowly somewhat upwardly from the closed elevator car or move somewhat slowly downwardly, whatever may be necessary for performance of his or her work. This situation is illustrated in FIG. 2. The service operative 20 is located in the interior of the elevator car 6, which here at the same time forms the permanent protective space.

In FIG. 3 it is especially shown how, thanks to this mobility of the elevator car 6 in the service mode, maintenance operations at the drives 23 of the shaft doors 11-13 can also be managed. The operative for that purpose travels with the elevator car 6 in the service mode to the desired point so that the operative is then located directly in front of the shaft door drive in the upper region of the relevant shaft door to be serviced. In FIG. 3 the elevator car 6 has been moved in this way to the drive 23 of shaft doors 11 of the lowermost access level 1. The elevator car door 24 can now be opened and the service personnel now has access from the elevator car 6, i.e. from the interior of the permanent protective space F, to the drive 23 of the shaft door 11 there, as well as also to the lower region of the shaft door 12 of the next higher access level 2. If necessary, the operative can close the car door 24 again and move centimeter-by-centimeter somewhat further upwardly or downwardly to any point desired by him or her. At the desired point the operative can subsequently open the elevator car doors 24 again in order to undertake work.

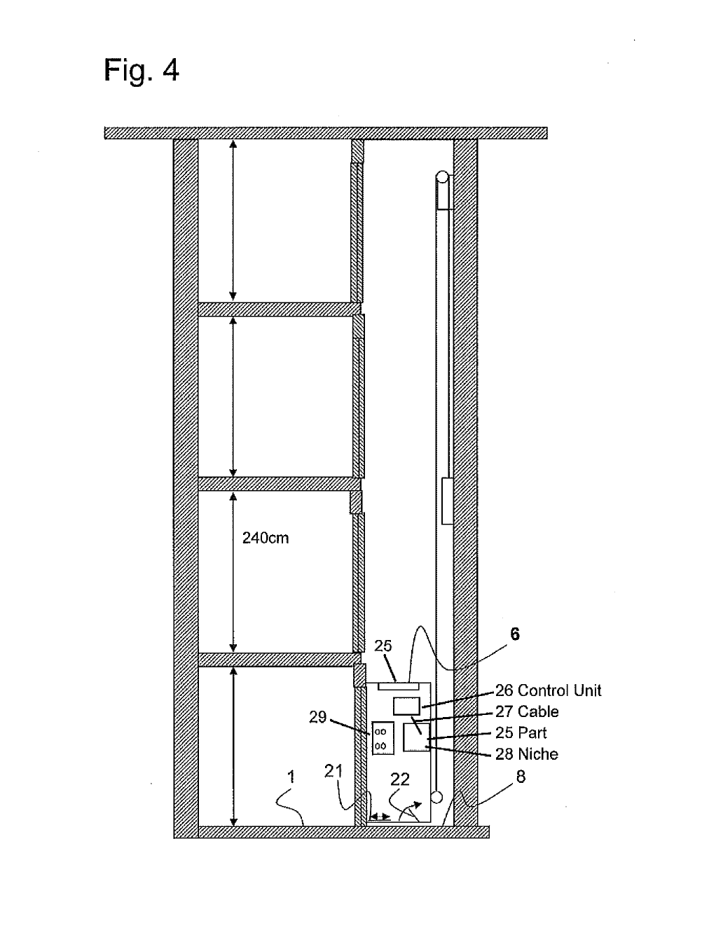

If for whatever reasons an object should drop down between the car door 24 and a shaft door 11-14 into the elevator shaft then this can be secured again in that the floor of the elevator car 6 can be partly or entirely removed from the elevator car 6. This is illustrated in FIG. 4. The floor of the elevator car 6 can for that purpose have one or more slides 21 or can have a door panel 22 which can be folded up into the elevator car 6, so that the entire elevator shaft floor 8 is reachable by a tool and objects can be secured by him or her. In addition, if, for example, a liquid has been spilled or oil has run out then this could be readily removed from the shaft floor via this opening hatch.

In accordance with the provisions of the patent statutes, the present invention has been described in what is considered to represent its preferred embodiment. However, it should be noted that the invention can be practiced otherwise than as specifically illustrated and described without departing from its spirit or scope.

1-10. (canceled)

11. An elevator comprising: an elevator car and a control unit, wherein the elevator is settable into a service mode and in this service mode the elevator car is movable by the control unit located in an interior of the car.

12. The elevator according to claim 11 wherein the control unit is accommodated behind a part, which can be removed, pivoted out or displaced, in a ceiling of the car.

13. The elevator according to claim 11 wherein the control unit is accommodated behind a wall part, which can be removed, pivoted open or displaced, in the interior of the car.

14. The elevator according to claim 11 wherein the control unit is accommodated behind a lighting part, which can be removed, pivoted open or displaced, in the interior of the elevator car.

15. The Elevator according to claim 11 wherein the control unit hangs at a cable and is removable from a storage niche so as to be actuable from any location in the interior of the car.

16. The elevator according to claim 11 wherein the control unit includes a keyboard with a plurality of buttons, the keyboard being arranged in the interior of the elevator car, wherein the keyboard in an operating mode of the elevator is an interface for destination input for a car journey.

17. The elevator according to claim 16 wherein the keyboard is activatable as the control unit for car travel in the service mode.

18. The elevator according to claim 17 wherein the keyboard is activatable as the control unit by input using a predeterminable button combination.

19. The elevator according to claim 17 wherein a button assignment of the keyboard is reconfigured in the service mode for input of a travel direction of the car, wherein on actuation of a first button the car is movable upwardly and on actuation of a second button the car is movable downwardly.

20. The elevator according to claim 17 wherein when the keyboard is activated as the control unit, the keyboard is deactivatable to change from the service mode to the operating mode by input using a predeterminable button combination.
